(19) United States
(12) Patent Application Publication
(10) Pub. No.: US 2025/0121755 A1
(43) Pub. Date: Apr. 17, 2025

(54) CUSHION, MANUFACTURING APPARATUS, AND A METHOD OF MANUFACTURE

(71) Applicant: Lear Corporation, Southfield, MI (US)

(72) Inventor: Eric Repke, Southfield, MI (US)

(73) Assignee: Lear Corporation, Southfield, MI (US)

(21) Appl. No.: 18/790,311

(22) Filed: Jul. 31, 2024

Related U.S. Application Data
(60) Provisional application No. 63/590,981, filed on Oct. 17, 2023.

(51) Int. Cl. B60N 2/70

(52) U.S. Cl. CPC B60N 2/7017; B60N 2/7035

(57) ABSTRACT

A cushion, a manufacturing apparatus, and a method of manufacture. The cushion comprises a mesh member that comprises a set of filaments. Each member of the set of filaments is looped and bonded to at least one other member of the set of filaments. The mesh member defines a first side that comprises a repeating non-planar profile.

### CROSS-REFERENCE TO RELATED APPLICATIONS

This application claims the benefit of U.S. provisional application Ser. No. 63/590,981, filed Oct. 17, 2023, the disclosure of which is hereby incorporated in its entirety by reference herein.

### TECHNICAL FIELD

This relates to a cushion comprising a mesh member, a manufacturing apparatus, and a method of manufacture.

### BRIEF DESCRIPTION OF THE DRAWINGS

FIG. 1 is a perspective view of an example of a seat assembly.

FIG. 2 is a perspective view of an example of a cushion of the seat assembly that comprises a mesh member or filament mesh structure.

FIG. 3 is schematic view of an example of a manufacturing system for making the filament mesh structure.

FIG. 4 is a side section view of an example of a funnel that may be provided with the manufacturing system.

FIG. 5 is a side section view of the funnel of FIG. 4 moved along multiple axes with respect to FIG. 4.

FIG. 6 is a plan view of the funnel of FIG. 4.

FIG. 7 is a plan view of the funnel of FIG. 6 moved along multiple axes with respect to FIG. 6.

FIG. 8 is a side section view of another example of a funnel with sides that are independently moveable.

FIG. 9 is a side section view of the funnel of FIG. 8 illustrating opposing sides moved toward each other.

FIG. 10 is a partial side section view of a funnel and a filament mesh structure with examples of a repeating non-planar profile after exiting the funnel.

FIG. 11 is a partial side section view of a funnel and a filament mesh structure with another example of a repeating non-planar profiles after exiting the funnel.

FIG. 12 is a partial side section view of a funnel and a filament mesh structure with an example of a repeating non-planar profile and a planar profile after exiting the funnel.

FIG. 13 is a partial side section view of a funnel and a filament mesh structure with an example of a repeating non-planar profile before exiting the funnel.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a” and “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

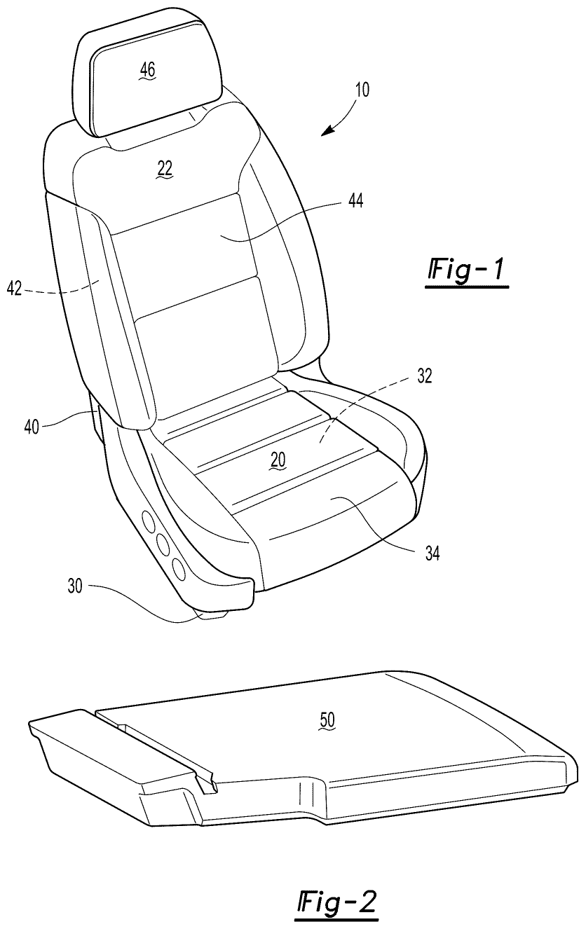

Referring to FIG. 1, an example of a seat assembly 10 is shown. In some embodiments, the seat assembly 10 is a vehicle seat assembly, such as for a land vehicle like a car, truck, bus, or the like, or for a non-land vehicle like aircraft or watercraft. For example, a seat assembly 10 for a land vehicle may be shaped and sized as a front row driver or passenger seat, a second, third, or other rear row seat, and may include bucket-style seats as shown, bench-style seats, or other seat styles. Furthermore, the seat assembly 10 may be a non-stowable seat or a stowable seat that may be foldable and stowable in a cavity in the vehicle floor. Additionally, the seat assembly 10 may be configured for non-vehicle applications such as furniture.

In the configuration shown in FIG. 1, the seat assembly 10 includes a seat bottom 20 and a seat back 22. It is contemplated that the seat back 22 may be omitted in some configurations, such as when the seat assembly 10 is configured as a motorcycle seat or stool.

The seat bottom 20 is configured to receive a seated occupant and support the pelvis and thighs of the seat occupant. The seat bottom 20 includes a seat bottom frame 30, a cushion 32, and a trim cover 34.

The seat bottom frame 30 is a structure that supports the cushion 32. The seat bottom frame 30 includes one or more structural members and may be made of any suitable material, such as a metal alloy, polymeric material, fiber reinforced polymeric material, or combinations thereof. In some configurations, the seat bottom frame 30 includes a panel, seat pan, suspension mat, or suspension wires upon which the cushion 32 is disposed.

The cushion 32 is disposed on the seat bottom frame 30. The cushion 32 is made of a compliant material that supports the seat occupant and distributes load forces from the seat occupant to the seat bottom frame 30. The cushion 32 and associated methods of manufacture will be discussed in more detail below.

The trim cover 34 covers at least a portion of the cushion 32. In addition, the trim cover 34 provides one or more visible exterior surfaces of the seat back 22. The seat occupant may be disposed on the trim cover 34 when seated upon the seat assembly 10. The trim cover 34 is made of any suitable material or materials, such as fabric, leather, leatherette, vinyl, or combinations thereof. The trim cover 34 may include a plurality of trim panels that are assembled in any suitable manner, such as by fusing or stitching. The trim cover 34 is attached to the seat bottom frame 30, the cushion 32, or both. For example, the trim cover 34 may include trim attachment features that are attached to the seat bottom frame 30, the cushion 32, or both, to inhibit removal of the trim cover 34 and help conform the trim cover 34 to the contour of the seat bottom frame 30, the cushion 32, or both. The trim cover 34 may also be attached to an attachment pad.

The seat back 22 is configured to support the back of a seated occupant. The seat back 22 is disposed adjacent to the seat bottom 20. For example, the seat back 22 may be disposed above the seat bottom 20 and near the rear side of the seat bottom 20. The seat back 22 extends in a generally upward direction away from the seat bottom 20. In some configurations, the seat back 22 is mounted to the seat bottom 20 and may be pivotable with respect to the seat bottom 20. In other configurations, the seat back 22 is not mounted to the seat bottom 20. For instance, a vehicle seat back may be mounted to the vehicle body structure, such as in some second row seat assemblies. The seat back 22 includes a seat back frame 40, a cushion 42, a trim cover 44, and optionally a head restraint 46.

The seat back frame 40 is a structure that supports the cushion 42. The seat back frame 40 includes one or more structural members and may be made of any suitable material, such as a metal alloy, polymeric material, fiber reinforced polymeric material, or combinations thereof. In some configurations, the seat back frame 40 includes a panel, pan, suspension mat, or suspension wires upon which the cushion 42 is disposed. It is also contemplated that the seat back frame 40 may be integrally formed with the seat bottom frame 30 in some configurations.

The cushion 42 is disposed on the seat back frame 40. The cushion 42 is made of a compliant material that supports the seat occupant and distributes load forces from the seat occupant to the seat back frame 40. It is contemplated that the cushion 42 may be integrally formed with the cushion 32 of the seat bottom 20 or may be separate from the cushion 32 of the seat bottom 20. The cushion 42 and associated methods of manufacture will be discussed in more detail below.

The trim cover 44 covers at least a portion of the cushion 42. In addition, the trim cover 44 provides one or more visible exterior surfaces of the seat back 22. The seat occupant may be disposed on the trim cover 44 when seated upon the seat assembly 10. The trim cover 44 is made of any suitable material or materials, such as fabric, leather, leatherette, vinyl, or combinations thereof. The trim cover 44 may include one trim panel or a plurality of trim panels that are assembled in any suitable manner, such as by fusing or stitching. The trim cover 44 is attached to the seat back frame 40, the cushion 42, or both. For example, the trim cover 44 may include trim attachment features that are attached to the seat back frame 40, the cushion 42, or both, to inhibit removal of the trim cover 44 and help conform the trim cover 44 to the contour of the seat back frame 40, the cushion 42, or both. The trim cover 44 may also be attached to an attachment pad.

The head restraint 46, if provided, is configured to support the head of a seat occupant. The head restraint 46 is disposed at the top of the seat back 22 or at an end of the seat back 22 that is disposed opposite the seat bottom 20. The head restraint 46 may be moveable in one or more directions with respect to the seat back 22 or may be integrally formed with the seat back 22.

Referring to FIG. 2, an example of a cushion 50 is shown. The cushion is generically designated with reference number 50 for convenience in reference. It is to be understood that the structure and description of the cushion 50 is applicable to the cushion 32 of the seat bottom 20, the cushion 42 of the seat back 22, or both.

The cushion 50 is a non-foam component or includes at least one non-foam component. The non-foam component is primarily referred to as a mesh member but may also be referred to as a stranded member, looped member, entangled member, filament mesh structure, mesh structure, stranded mesh, looped mesh, entangled mesh, or mesh cushion. In FIG. 2, the cushion 50 is depicted as a non-foam component that does not include a foam component or foam material, such as urethane or polyurethane foam; however, it is contemplated that the cushion 50 may also include a foam component or foam material in addition to a non-foam component to provide additional cushioning or localized cushioning for a seat occupant. For example, foam material may be provided between the cushion 50 and a trim cover (e.g., trim cover 34, 44) that is disposed on the cushion 50, within the cushion 50, or combinations thereof. Reducing the amount of foam material that is provided with the cushion 50 or eliminating foam material from the cushion 50 reduces weight and may improve support and comfort of a seat occupant. In addition, eliminating foam material may facilitate recycling of the cushion 50.

The cushion 50 is described below in the context of a cushion 50 that does not include foam material. In this context, the cushion 50 is made of filaments 52 of polymeric material that are randomly looped, bent, curled, or entangled and are bonded together as will be discussed in more detail below. Examples of filaments 52 are shown in FIGS. 10-13. A filament 52 is directly bonded to another filament 52 rather than being indirectly bonded with a resin or other intermediate material.

The filaments 52, which may also be referred to as strands or threads, are made of any suitable material or materials. In some configurations, the filaments 52 are made of a polymeric material or thermoplastic material, such as a thermoplastic resin that is polyamide-based, polyester-based, polyimide-based, polyolefin-based (e.g., polypropylene-based, polyethylene- based, etc.), polystyrene-based, or combinations thereof. As one example, a polyethylene-based filament may be made of linear low density polyethylene (LLPDE). The filament material may be recyclable unlike foam material or more easily recycled than foam material. It is also contemplated that a filament 52 may comprise reinforcement fibers and that the reinforcement fibers may not be made of a thermoplastic material.

In some configurations, a filament 52 may be a monofilament that is made of a single material. In some configurations, a filament 52 is made of multiple materials. As an example, a filament 52 made of multiple materials may include a core that is made of a first thermoplastic material and a sheath that encircles the core and is made of a second thermoplastic material that differs from the first thermoplastic material. It is contemplated that the cushion 50 may include a combination of monofilaments and filaments that are made of multiple materials and are not monofilaments.

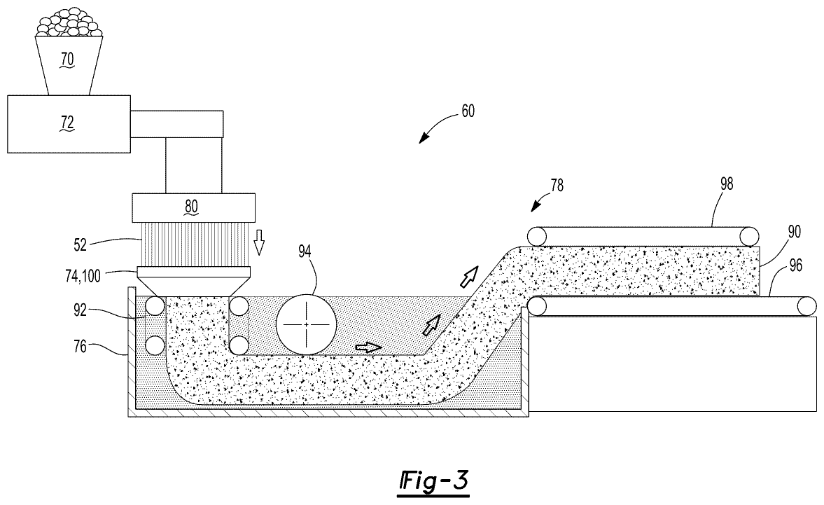

Filaments 52 that are randomly looped, bent, looped, curled, or entangled are bonded together where one filament 52 contacts another filament 52, thereby resulting in a lightweight, air permeable cushion (e.g., cushion 32 and/or 42) or mesh structure having openings or voids between the filaments 52. An example of a manufacturing system 60 of making a cushion or filament mesh structure is also shown in FIG. 3. In this example, the manufacturing system 60 includes a material supply 70, an extruder 72, and a funnel 74. The manufacturing system 60 also includes a cooling tank 76 and a material handling subsystem 78.

Referring to FIG. 3, the material supply 70 holds material stock that is to be extruded, such as solid beads, flakes, granules, pellets, or powder made of the material. In some configurations, the material supply 70 is configured as a container or hopper. The material supply 70 provides material stock to the extruder 72.

The extruder 72 melts the material stock and extrudes the material stock into a set of filaments 52. The extruder 72 may have any suitable configuration. In some configurations, the extruder 72 includes a barrel that receives a rotatable screw and heating elements. Rotation of the screw forces the material to move through the barrel and helps heat the material due to the friction generated as the screw rotates. The material exits the barrel under pressure and in a molten state and is transported under pressure to a die 80 of the extruder 72.

The die 80, which may also be referred to as a die plate or extrusion die, has multiple through holes or filament forming openings through which the molten material passes. A single filament 52 is extruded from each through hole. The filaments 52 fall downward from the die 80 under the force of gravity into the funnel 74.

The funnel 74 consolidates or groups the filaments 52 into a more compact arrangement in which the filaments bend, curl, or loop and each filament 52 contacts and bonds to at least one other filament 52. The funnel 74 has an inlet opening or funnel inlet and an outlet opening or funnel outlet that is smaller than the funnel inlet. Individual separated filaments 52 enter the funnel inlet. The filaments 52 bend, curl, or loop and move into contact as they accumulate. The filaments 52 move through the funnel 74 toward the funnel outlet. Some filaments may slide along the funnel 74 or an intervening sheet that is disposed on the funnel 74 as the filaments move toward the funnel outlet. Bonds are formed between filaments 52 at the points of contact while openings or voids between filaments 52 are present at other locations where one filament 52 does not contact or bond to another filament 52. The entangled and bonded filaments 52 pass through the funnel outlet of the funnel 74 and enter the cooling tank 76. For convenience in reference, the bonded filaments 52 are referred to as a mesh member or filament mesh structure 90.

The cooling tank 76 holds a liquid, such as water or a mixture of water and another fluid. The liquid in the cooling tank 76 helps support the entangled and bonded filaments 52 to limit further compacting or consolidation of the filaments 52 into a less open or less porous arrangement and maintains a desired porosity and density of the filament mesh structure 90. Thus, the liquid provides some buoyancy or resistance that can result in additional bending, curling, or looping of the filaments 52 adjacent to the surface of the liquid or within the funnel 74 to further build the filament mesh structure 90. The liquid also cools the filaments 52 when the filaments 52 are in the liquid. For instance, the liquid cools the filaments 52 from the outside to solidify the filaments 52 and prevent the filaments 52 from bonding at additional locations. At this point, the filaments 52 are relatively stiff and no longer in a plastic state and thus generally maintain a shape and are not moldable or reformable without being reheated.

The material handling subsystem 78 transports the filament mesh structure 90 through the cooling tank 76. The material handling subsystem 78 includes various rollers and conveyors that help move the filament mesh structure 90 through the liquid and out of the liquid. In some configurations, a tractor conveyor 92 is provided in the cooling tank 76 to help pull the filament mesh structure 90 away from the funnel 74 and to counter buoyancy of the filaments 52.

One or more other rollers, such as roller 94, keep the filament mesh structure 90 submerged in the liquid and guide the filament mesh structure 90 through the cooling tank 76. For example, the roller 94 may guide the filament mesh structure 90 toward a conveyor belt 96 and shaker table 98 that are disposed outside of the cooling tank 76. The shaker table 98 shakes the filament mesh structure 90 while it is on the conveyor belt 96 to remove liquid. Alternatively or in addition, the filament mesh structure 90 may be squeezed to remove liquid, air may be blown toward the filament mesh structure 90 to help remove liquid from the filament mesh structure 90, or both. It is also contemplated that the filament mesh structure 90 may also be allowed to drip dry, or dry in ambient air.

The manufacturing system 60 described above is a continuous flow process in which the filament mesh structure 90 is formed as a continuous structure when filament extrusion is not interrupted. Further processing of the filament mesh structure 90 is provided after exiting the cooling tank 76 to cut the filament mesh structure 90 into individual pieces or blanks for individual cushions. Such processing is conducted by a cutting system of the manufacturing system 60. The cutting system may be of any suitable type. For instance, the cutting system may employ a blade, knife, hot knife, saw, fluid jet, or the like to cut the filaments 52 of the filament mesh structure 90 into a blank. The cutting system may be used to shape or contour the blank. It is also contemplated that a blank may be further shaped or contoured with other manufacturing processes, such as molding of the entire blank or a portion thereof.

With the above process, the cushion 50 may be formed of a set of filaments 52, wherein at least two members of the set of filaments 52 are looped and bonded to each other. In one or more embodiments, each member of the set of filaments 52 is looped and bonded to at least one other member of the set of filaments.

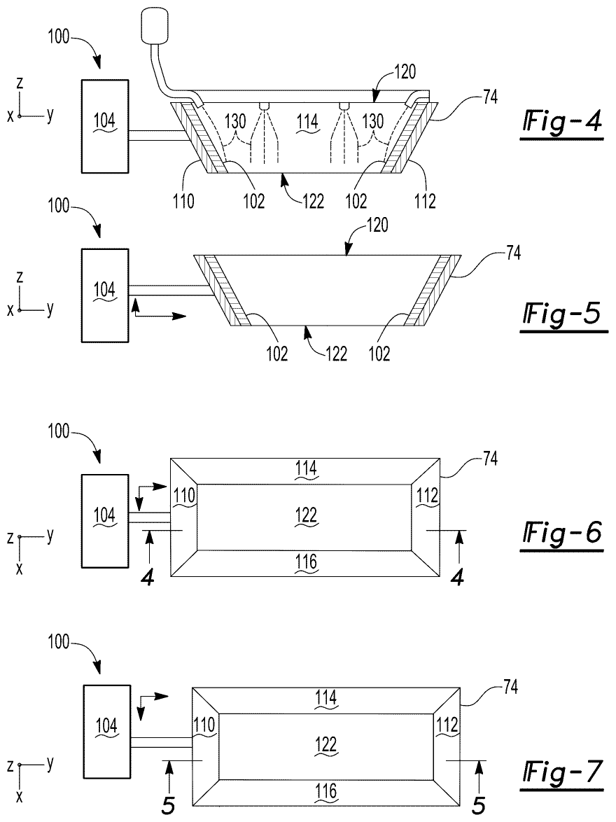

Referring to FIG. 4, an example of a funnel subsystem is shown. For convenience in reference, the funnel subsystem is referred to as an apparatus 100. The apparatus 100 is configured to vibrate one or more sides of the funnel 74. Vibrating the funnel 74 allows the mesh member or filament mesh structure 90 to be provided with a repeating non-planar profile as will be discussed in more detail below. In addition, vibrating the funnel 74 may help keep the filaments 52 from sticking to the funnel 74 or sticking to a sheet 102 that may optionally be disposed on the funnel 74. In some configurations, the apparatus 100 includes the funnel 74 and one or more actuators 104.

The funnel 74 comprises a set of sides. In the configuration shown, the set of sides includes a first side 110, a second side 112, a third side 114, and the fourth side 116; however, it is contemplated that a greater or lesser number of sides may be provided. For instance, the funnel 74 may have two or more sides that may or may not be moveable with respect to each other.

The set of sides cooperate to define an inlet opening 120 and an outlet opening 122 of the funnel 74. The inlet opening 120 is disposed at the top of the funnel 74, or closer to the extruder 72 and the die 80 than the outlet opening 122 is disposed to the extruder 72 and the die 80. As such, filaments 52 enter the funnel 74 through the inlet opening 120 and exit the funnel 74 through the outlet opening 122. Filaments 52 exit the funnel 74 via the outlet opening 122. The filaments 52 may not be entangled and bonded when the filaments 52 enter the inlet opening 120 and may be entangled and bonded when the filaments 52 exit the outlet opening 122.

Members of the set of sides may be provided in various configurations. For instance, one or more members of the set of sides may be angled or sloped such that the funnel 74 becomes narrower in a direction that extends from the inlet opening 120 to the outlet opening 122. As such, the inlet opening 120 may be larger than the outlet opening 122. Said differently, the inlet opening 120 may have a larger area than the outlet opening 122, such as when viewed from above or along the Z axis shown in FIG. 4. The Z axis may be a vertical axis or axis oriented in a vertical direction in which the filaments 52 fall from the die 80 toward the inlet opening 120.

In some configurations, a sheet 102 is disposed on some or all members of the set of sides. The sheet 102 may be disposed inside the funnel 74. The sheet 102 may extend along an upward facing surface of a side of the funnel 74. In some configurations, an upward facing surface extends between the inlet opening 120 and the outlet opening 122. For instance, a sheet 102 may contact or engage the surface and may extend from the inlet opening 120 to or toward the outlet opening 122. As such, the sheet 102 separates the filaments 52 from a corresponding side of the funnel 74 such that one or more filaments 52 may contact an interior facing surface of the sheet 102 that faces toward the passage through the funnel 74 and that is disposed opposite an exterior facing surface of the sheet 102 that faces toward and may contact a corresponding side of the funnel 74. It is also contemplated that a gap may be provided between the sheet 102 and the funnel 74 or a side of the funnel 74.

The sheet 102 may have any suitable configuration. For instance, the sheet 102 may be made of any suitable material or materials, such as a polymeric material or materials, an example of which is nylon. The sheet 102 may be a film, fabric, woven layer, or non-woven layer. The sheet 102 may or may not be liquid permeable. In some configurations, a fluid 130, such as a gas, gas mixture (e.g., air), liquid (e.g., water), or combinations thereof, is dispensed onto the sheet 102 to help prevent filaments 52 from sticking to the sheet 102. For example, fluid 130 may be dispensed or directed onto the interior facing surface of the sheet 102 that faces toward the center of the funnel 74, an example of which is shown in FIG. 4 and is omitted from FIGS. 5-7 for clarity. In such a configuration, the sheet 102 may or may not be liquid permeable.

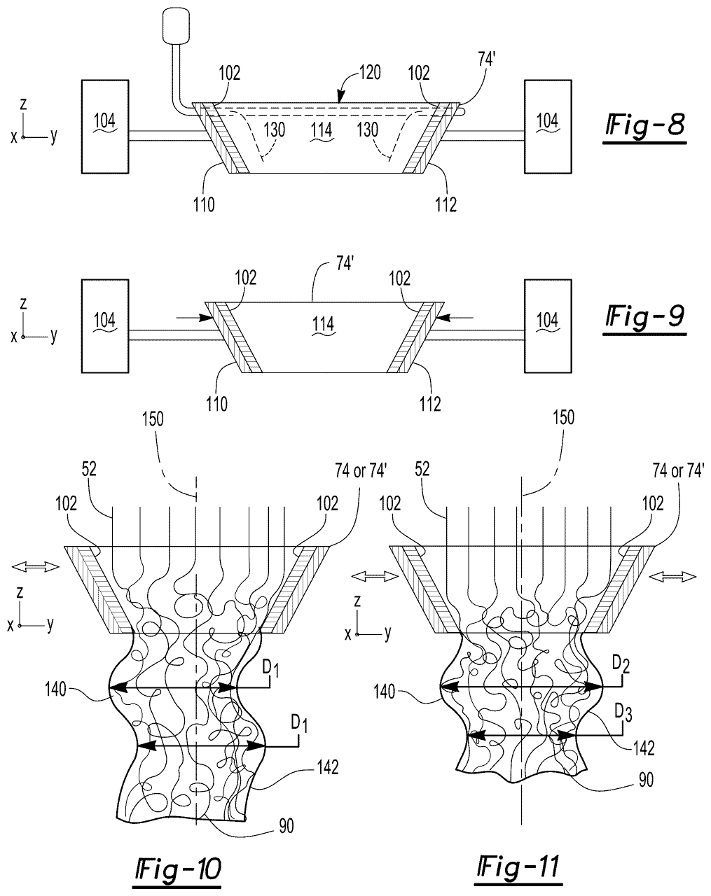

In some configurations, the sheet 102 is liquid permeable and allows the fluid 130 to be dispensed through or pass through pores, holes, or openings in the sheet 102, and thus allow the fluid 130 to pass through the sheet 102 from the exterior facing surface to the interior facing surface, an example of which is best shown in FIG. 8 but is omitted from FIG. 9 for clarity. It is also contemplated that a sheet 102 may be omitted from some or all sides of the funnel 74, in which case the fluid 130 may be dispensed onto an interior facing surface of the funnel 74.

It is contemplated that fluid may be dispensed onto an interior facing surface of the sheet 102, pass through the sheet 102 to reach the interior facing surface of the sheet 102, or combinations thereof in any of the configurations disclosed herein. For instance, FIG. 4 could have a configuration like that shown in FIG. 8 or vice versa.

One or more actuators 104 are provided to vibrate one or more sides of the funnel 74. An actuator 104 is configured to vibrate one or more sides of the funnel 74 along one or more axes, such as X, Y, and Z axes that intersect and are disposed perpendicular to each other. Examples of such axes are illustrated in FIGS. 4 through 9. An actuator 104 may be of any suitable type. For instance, an actuator 104 may be configured as a haptic motor or vibration motor. As some examples, the actuator 104 may be an eccentric rotating mass (ERM) vibration motor, a linear resident actuator (LRA), a solenoid actuator, or the like. In some configurations, the actuator 104 is configured to move back-and-forth along at least one axis over a predetermined or variable distance and at a predetermined or variable frequency. As an example, movement may occur over a distance of 10 mm or less, such as 0.5 mm and at a frequency of 300 Hz or less such as 60 Hz. Vibrating a side of the funnel 74 transmits energy to at least a subset of the set of filaments 52, such as the filaments 52 that contact a corresponding side of the funnel 74 or sheet 102 that is disposed on a corresponding side of the funnel 74. Such filaments 52 or a portion thereof may be positioned along the perimeter of the mesh member or filament mesh structure 90. Vibration transfers energy to at least a subset of the set of filaments 52 and shapes the at least a portion of the subset of the set of filaments 52 with a non-planar profile. For instance, vibration energy may cause regions of filaments 52 that are engaged by a vibrating side of the funnel 74 to bend. Bending may produce a repeating pattern (e.g., a repeating profile along one or more sides) or a non-repeating pattern (a non-repeating profile along one or more sides). The non-planar profile or profile pattern may be function of the vibration frequency of a corresponding side of the funnel 74 and produces a non-planar profile or contour along the perimeter of the mesh member or filament mesh structure 90 as will be discussed in more detail below.

In some configurations, such as the configuration shown in FIGS. 4-7, the funnel 74 is configured such that the set of sides of the funnel 74 are fixedly positioned with respect to each other. In such a configuration, the actuator 104 vibrates the funnel 74 and all members of the set of sides move together or in unison along one or more axes. FIGS. 4-7 illustrate vibration of the funnel 74 along three axes; however, it is to be understood that vibration may occur along a lesser number of axes, such as two axes or a single axis.

An example of movement or vibration along the Y and Z axes is best understood by comparing FIGS. 4 and 5. In FIG. 4, the funnel 74 is shown in an example of a first position. In FIG. 5, the funnel 74 is moved along the Y and Z axes with respect to FIG. 4. In FIG. 5, the funnel 74 is moved away from the actuator 104 along the Y axis or to the right from the perspective shown with respect to the funnel position shown in FIG. 4. Similarly, in FIG. 5 the funnel 74 is moved upward along the Z axis from the perspective shown with respect to the funnel position shown in FIG. 4. It is contemplated that the actuator 104 may move the funnel 74 along a corresponding axis back to the position shown in FIG. 4 to complete an oscillation or vibration cycle along that axis.

An example of movement or vibration along the X and Y axes is best understood by comparing FIGS. 6 and 7. In FIG. 6, the funnel 74 is shown in the first position from above the funnel 74. In FIG. 7, the funnel 74 is moved along the X and Y axes with respect to FIG. 6. In FIG. 7, the funnel 74 is moved away from the actuator 104 along the Y axis or to the right from the perspective shown. Similarly, in FIG. 7 the funnel 74 is moved along the X axis with respect to the funnel position in FIG. 6. It is contemplated that the actuator 104 may move the funnel 74 along a corresponding axis back to the position shown in FIG. 6 to complete an oscillation or vibration cycle along that axis.

Vibrating the funnel 74 and all sides of the funnel 74 along one or more axes in unison does not change the area of the inlet opening 120 and the outlet opening 122. It is also contemplated that the area of the inlet opening 120 and the outlet opening 122 may not change when at least one side of the funnel 74 is independently moveable or vibratable with respect to at least one other side of the funnel 74 but all sides of the funnel 74 are vibrated together or in unison.

An example of another configuration of a funnel 74′ is shown in FIGS. 8 and 9. The funnel 74′ in this configuration may share characteristics of the funnel 74 previously described but is configured such that at least one member of the set of sides is moveable or vibratable (i.e., able to be vibrated) with respect to at least one other member of the set of sides of the funnel.

-One or more actuators 104 may be operatively connected to the funnel 74′. In some configurations, each member of the set of sides or each side of the funnel 74′ may be coupled to a corresponding actuator 104 and the actuator 104 may be configured to vibrate a corresponding side of the funnel 74′, such as with respect to one or more other sides of the funnel 74′. For instance, the first side 110, the second side 112, third side 114, and the fourth side 116 may each be coupled to a corresponding actuator 104 that vibrates one corresponding side.

It is also contemplated that two or more sides may be fixedly positioned with respect to each other and that an actuator 104 may vibrate the sides that are fixedly positioned with respect to each other together or in unison. As an example, a pair of sides, such as the first side 110 and the second side 112, may be vibratable by a corresponding actuator 104 with respect to the third side 114 and the fourth side 116. A pair of sides that are vibrated by a corresponding actuator 104 may be disposed adjacent to each other or may not be disposed adjacent to each other, such as when a pair of sides are disposed opposite each other or another side of the funnel 74′ that is not vibrated by the corresponding actuator 104 is disposed between the pair of sides. Vibrating a side of the funnel 74′ may vary the area of the inlet opening 120, the outlet opening 122, or both. As such, an area of the inlet opening 120, the outlet opening 122, or both may be variable rather than constant.

It is contemplated that one or more sides of the funnel 74′ may be stationary and that one or more other sides of the funnel 74′ may be vibratable with respect to a stationary side of the funnel 74′.

An actuator 104 is configured to vibrate at least one associated funnel side along one or more axes. An example of movement or vibration of different members of the set of sides of the funnel 74′ along the Y axis is best understood by comparing FIGS. 8 and 9. Movement along the Y axis is used for illustration purposes. As such it is to be understood that movement along the X axis, the Z axis, or any combination of the X, Y, and Z axes is contemplated.

In FIG. 8, the first side 110 and the second side 112 of the funnel 74′ are coupled to different actuators 104 and are shown in respective first positions.

In FIG. 9, the first side 110 and the second side 112 are moved toward each other along the Y axis by the actuators 104, 104. Moving the first side 110 and the second side 112 toward each other reduces the distance between the first side 110 and the second side 112 and changes the shape or size of the inlet opening 120 and the outlet opening 122. For instance, the area of the inlet opening 120 and the area of the outlet opening 122 is reduced when the first side 110 and the second side 112 are move toward each other and the distance between the third side 114 and the fourth side 116 (which is not visible in FIGS. 8 and 9) is maintained or decreased. In this example, it is contemplated that the actuators 104, 104 may move the first side 110 and the second side 112 back to the position shown in FIG. 8 to complete an oscillation or vibration cycle.

It is also contemplated that the area of the inlet opening 120, area of the outlet opening 122, or both, may change when at least one side of the funnel 74′ is vibrated with respect to at least one other side of the funnel 74′, such as at a different amplitude, different frequency, different direction, or combinations thereof, or when at least one side of the funnel 74′ is vibrated with respect to a stationary funnel side.

Referring to FIGS. 10-12, some examples of the mesh member or filament mesh structure 90 with non-planar profiles are shown. In these figures, as well as FIG. 13, the actuator or actuators 104 are omitted for clarity. In these examples, the non-planar profile is visible or present when the filaments 52 have exited the outlet opening 122 of the funnel 74, 74′.

The non-planar profile is provided on one or more sides of the mesh member or filament mesh structure 90. In some configurations, the non-planar profile is a repeating non-planar profile in which the profile repeats along a side of the mesh member or filament mesh structure 90. For instance, a repeating non-planar profile is not planar and may be a waveform or have the shape of a wave.

A waveform comprises any suitable wave shape, such as a sinusoidal waveform, square waveform, triangular waveform, sawtooth waveform or the like.

For instance, a sinusoidal waveform is shaped like or varies according to a sine curve or a sine wave.

A square waveform is a non-sinusoidal waveform that varies periodically an abruptly from one to the other of two uniform values or uniform positions or axial distances.

A triangular waveform is a non-sinusoidal waveform having a triangular shape that may be periodic and piecewise linear.

A sawtooth waveform is a non-sinusoidal waveform that resembles the teeth of a ramp or plain-toothed saw with a zero rake angle.

A waveform or a portion thereof may be a periodic waveform. A periodic waveform repeats over a specified distance or occurs and recurs at regular or repeating distance intervals. The term non-planar profile is employed to designate the profile or contour from filament to filament along one or more sides of the mesh member or filament mesh structure 90 as if voids between filaments 52 were not present, such as if a thin film was placed in contact with the filaments 52 and bridged the gap between filaments 52 without sagging into a void between filaments 52. A non-planar profile may be the profile of an exterior side or perimeter side of the mesh member or filament mesh structure 90 along a section plane through that side. In some configurations, a non-planar profile is visible along an entire side of the mesh member or filament mesh structure 90 when viewed along an axis, such as an axis that is perpendicular to the direction in which filaments 52 are extruded.

In the examples below, vibration may occur in a horizontal plane, such as along the X axis, Y axis, or combinations thereof. Vibration in a horizontal plane may produce a non-planar profile that resembles a “vertical wave” in or after exiting the funnel 74, 74′. In some configurations, the non-planar profile that is provided improves deformation resistance of the mesh member or filament mesh structure 90 at or near a corresponding side of the mesh member or filament mesh structure 90. The non-planar profile may make the mesh member or filament mesh structure 90 easier to grip and secure and may provide a contour that helps grip or maintain the position of a trim cover that is disposed on the mesh member or filament mesh structure 90.

Referring to FIG. 10, an example of a mesh member or filament mesh structure 90 having a non-planar profile along opposing first and second sides 140, 142 of the mesh member or filament mesh structure 90 is shown. The solid wave-like lines along the first and second sides 140, 142 designate the non-planar profile.

In this example, the non-planar profiles are illustrated as being sinusoidal and in phase with each other. As such, the distance D1 between the non-planar profile of the first side 140 and the non-planar profile of the second side 142 may be constant or substantially constant. In this example, the non-planar profile of the first side 140 extends farther away from a central reference plane 150 as the non-planar profile of the second side 142 extends farther toward the central reference plane 150 and vice versa. In some configurations, the central reference plane 150 is aligned with the Z axis or in a vertical direction in which the filaments 52 fall from the extruder 72.

As such, as the first side 140 moves to the left from the perspective shown and away from the central reference plane 150 as the second side 142 moves left from the perspective shown and toward the central reference plane 150. Conversely, as the first side 140 moves to the right toward the central reference plane 150 from the perspective shown, the second side 142 also moves to the right and away from the central reference plane 150.

Such a configuration may be provided with a funnel 74 having fixed sides by vibrating the funnel 74 along the Y axis, or left and right from the perspective shown as represented by the double arrowed line.

Such a configuration may also be provided with the funnel having first and second sides 110, 112 that each have a corresponding actuator 104 or that are fixedly positioned with respect to each other and that are moveable together with respect to another member of the set of sides, such as the third side 114 or the fourth side 116. For instance, this configuration may be provided using the funnel 74′ shown in FIGS. 8 and 9 by actuating the first and second sides 110, 112 in unison and in the same direction with their corresponding actuators 104, 104.

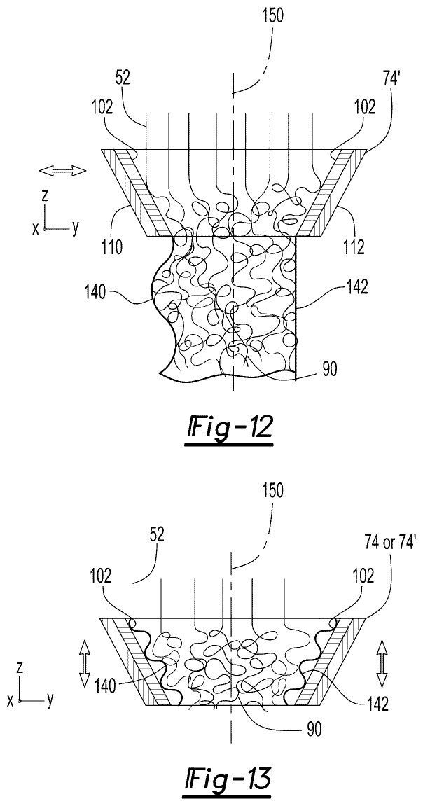

Referring to FIG. 11, another example of a mesh member or filament mesh structure 90 having a non-planar profile along opposing first and second sides 140, 142 is shown. In this configuration, the non-planar profiles are illustrated as being sinusoidal and out of phase with each other. As such, the distance between the first and second sides 140, 142 along an axis, such as the Y axis, varies as the mesh member or filament mesh structure 90 extends along the central reference plane 150.

In this example, the non-planar profile of the first side 140 extends farther away from the central reference plane 150 as the non-planar profile of the second side 142 extends farther away from the central reference plane 150 and vice versa. In such a configuration, the distance D2 between the first and second sides 140, 142 is greater than the distance D3 between the first and second sides 140, 142. Distance D2 may be a location at which the first and second sides 140, 142 are farthest from each other or farthest from the central reference plane 150 while distance D3 may correspond with a location at which the first and second sides 140, 142 are closest to each other or closest to the central reference plane 150.

The configuration shown in FIG. 11 may be provided using the funnel 74′ and by actuating the first and second sides 110, 112 of the funnel 74′ simultaneously away from each other to increase the distance between the first and second sides 140, 142 and simultaneously toward each other to decrease the distance between the first and second sides 140, 142.

Referring to FIG. 12, an example of a mesh member or filament mesh structure 90 is shown that includes a repeating non-planar profile along the first side 140 and that does not include a repeating non-planar profile along the second side 142. In some configurations, a side that does not include a repeating non-planar profile is substantially planar, is non-planar (e.g., curved, includes multiple non-planar segments, etc.) but does not have a repeating pattern in at least one axial direction along the side, or combinations thereof.

The non-planar profile may be provided using a funnel that has at least one side that is moveable with respect to another side of the funnel. For instance, this configuration may be provided using the funnel 74′ shown in FIGS. 8 and 9 by actuating the first side 110 toward and away from the central reference plane 150 while keeping the second side 112 stationary. It is also to be understood that this configuration may also be provided using a funnel that does not have an actuator 104 that actuates an opposing side, such as the second side 142. The planar profile of the second side 142 may or may not be disposed parallel to the central reference plane 150.

It is also contemplated that one or more sides of the funnel 74′ may be vibrated in a manner that helps align filaments 52 with a “smoother” profile or more planar profile along one or more sides, such as the second side 142 depicted in FIG. 12. For example, vibrating a funnel side at an appropriate frequency may help align filaments 52 along that funnel side in a generally vertical direction, thereby resulting in a more planar profile when viewed along the X axis. It is contemplated that in some configurations a wavelike profile from filament to filament or between filaments may be present when viewed along the Y axis.

Referring to FIG. 13, another example of a mesh member or filament mesh structure 90 with non-planar profiles shown. In this example, the non-planar profile is provided or present inside the funnel 74, 74′, such as after the filaments 52 have entered the inlet opening 120 and before the filaments 52 have exited the outlet opening 122.

The non-planar profile may be provided on one or more for sides of the mesh member or filament mesh structure 90. In this example, the non-planar profile is illustrated as being provided along or with the first and second sides 140, 142 of the mesh member or filament mesh structure 90 by moving the funnel 74, 74′ or first and second sides 110, 112 of the funnel 74, 74′ along at least the Z axis. The Z axis may be disposed substantially parallel to the central reference plane 150. However, it is contemplated that the non-planar profile may be provided on a greater or lesser number of sides of the mesh member or filament mesh structure 90, different sides than those shown, or combinations thereof.

In some embodiments, the non-planar profile is provided or present inside the funnel 74, 74′ with any of the configurations previously described, such as the configurations in FIGS. 4-12. In some embodiments, one or more funnel sides may also be vibrated along one or more axes in addition to the Z-axis, such as the X axis, Y axis, or both.

Moving or vibrating the first and second sides 110, 112 along the Z axis may cause the filaments 52 to “bounce” from a corresponding side of the funnel 74, 74′ and bend to produce a non-planar profile. As a result, the non-planar profile or waveform may extend or repeat in a direction that is substantially parallel to a corresponding interior facing surface of a side of the funnel 74, 74′. Vibrating the funnel 74, 74′ in this manner may help prevent filaments from sticking to the sheet 102, if provided, or a side of the funnel 74, 74′ when a sheet 102 is not provided upon a side of the funnel 74, 74′.

It is contemplated that vibration in a vertical direction or along the Z axis may allow the sheet 102 onto to be omitted from some or all sides of the funnel 74, 74′. It is contemplated that vibration in a vertical direction may result in the mesh member or filament mesh structure 90 that has a non-planar profile when the filaments 52 exit the outlet opening 122 of the funnel 74, 74′.

Vibrating a side of the funnel 74′ results in the transmission of force to at least a subset of the set of filaments 52 that make up the mesh member or filament mesh structure 90. As a result, vibrating at least one member of the set of sides of a funnel 74, 74′ against a subset of the set of filaments 52 shapes a subset of the set of filaments 52 with a non-planar profile.

In some configurations, such as the configurations in FIGS. 10-13, filaments 52 associated with a non-planar profile may be sufficiently cooled and stiffened, such as by fluid 130 dispensed at the funnel 74, 74′, so that a non-planar profile is present when the filaments 52 reach the cooling tank 76, where further cooling and stiffening may occur.

Clause 1. An apparatus comprising: a funnel comprising a set of sides that cooperate to define an inlet opening and an outlet opening; and an actuator that is operatively connected to the funnel, wherein at least one member of the set of sides is vibratable by the actuator.

Clause 2. The apparatus of clause 1 wherein the set of sides are fixedly positioned with respect to each other and the set of sides are vibratable by the actuator.

Clause 3. The apparatus of any preceding clause further comprising a sheet that is disposed on at least one member of the set of sides and that faces toward the inlet opening, wherein the sheet is vibratable with the at least one member of the set of sides.

Clause 4. The apparatus of clause 1 or clause 3 when dependent on clause 1 wherein a first member of the set of sides is moveable with respect to a second member of the set of sides.

Clause 5. The apparatus of clause 4 wherein an area of the inlet opening and an area of the outlet opening is variable.

Clause 6. The apparatus of clause 4 or clause 5 further comprising a second actuator, wherein the first member of the set of sides is vibratable by the actuator and the second member of the set of sides is vibratable with the second actuator.

Clause 7. The apparatus of clause 6 wherein the first and second members of the set of sides are disposed opposite each other, and the actuator and the second actuator is configured to move the first and second members of the set of sides, respectively, toward each other.

Clause 8. A method comprising: extruding a set of filaments into a funnel, the funnel comprising a set of sides and an outlet opening that is defined by the set of sides; and vibrating at least one member of the set of sides of the funnel against a subset of the set of filaments, thereby shaping the subset of the set of filaments with a non-planar profile.

Clause 9. The method of clause 8 wherein vibrating changes an area of the outlet opening.

Clause 10. The method of clause 8 wherein vibrating further comprises vibrating the set of sides without changing an area of the outlet opening.

Clause 11. The method of any one of clauses 8 to 10 wherein extruding the set of filaments further comprises extruding the set of filaments through a die and vibrating further comprises vibrating at least one member of the set of sides toward and away from the die while extruding the set of filaments.

Clause 12. The method of any one of clauses 8 to 11 further comprising dispensing a fluid onto at least one member of the set of sides while vibrating at least one member of the set of sides.

Clause 13. The method of any one of clauses 8 to 12 further comprising dispensing a fluid onto a sheet that is disposed on at least one member of the set of sides while vibrating at least one member of the set of sides.

Clause 14. The method of any one of clauses 8 to 13 further comprising dispensing a fluid through a sheet that is disposed on at least one member of the set of sides while vibrating at least one member of the set of sides.

Clause 15. A cushion comprising: a mesh member comprising a set of filaments of thermoplastic material, wherein each member of the set of filaments is looped and bonded to at least one other member of the set of filaments, the mesh member defining a first side that comprises a repeating non-planar profile.

Clause 16. The cushion of clause 15 wherein the mesh member further comprises a second side and comprises a second repeating non-planar profile.

Clause 17. The cushion of clause 15 wherein the mesh member further comprises a second side that is disposed opposite the first side and the second side does not comprise a repeating non-planar profile.

Clause 18. The cushion of any one of clauses 15 to 17 wherein the repeating non-planar profile is a waveform.

Clause 19. The cushion of any one of clauses 15 to 18 wherein the repeating non-planar profile is a periodic waveform.

Clause 20. The cushion of clause 19 wherein the repeating non-planar profile is a sinusoidal waveform.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. An apparatus comprising:
a funnel comprising a set of sides that cooperate to define an inlet opening and an outlet opening; and
an actuator that is operatively connected to the funnel, wherein at least one member of the set of sides is vibratable by the actuator.

2. The apparatus of claim 1 wherein the set of sides are fixedly positioned with respect to each other and the set of sides are vibratable by the actuator.

3. The apparatus of claim 1 further comprising a sheet that is disposed on at least one member of the set of sides and that faces toward the inlet opening, wherein the sheet is vibratable with the at least one member of the set of sides.

4. The apparatus of claim 1 wherein a first member of the set of sides is moveable with respect to a second member of the set of sides.

5. The apparatus of claim 4 wherein an area of the inlet opening and an area of the outlet opening is variable.

6. The apparatus of claim 4 further comprising a second actuator, wherein the first member of the set of sides is vibratable by the actuator and the second member of the set of sides is vibratable with the second actuator.

7. The apparatus of claim 6 wherein the first and second members of the set of sides are disposed opposite each other, and the actuator and the second actuator is configured to move the first and second members of the set of sides, respectively, toward each other.

8. A method comprising:
extruding a set of filaments into a funnel, the funnel comprising a set of sides and an outlet opening that is defined by the set of sides; and
vibrating at least one member of the set of sides of the funnel against a subset of the set of filaments, thereby shaping the subset of the set of filaments with a non-planar profile.

9. The method of claim 8 wherein vibrating changes an area of the outlet opening.

10. The method of claim 8 wherein vibrating further comprises vibrating the set of sides without changing an area of the outlet opening.

11. The method of claim 8 wherein extruding the set of filaments further comprises extruding the set of filaments through a die and vibrating further comprises vibrating at least one member of the set of sides toward and away from the die while extruding the set of filaments.

12. The method of claim 8 further comprising dispensing a fluid onto at least one member of the set of sides while vibrating at least one member of the set of sides.

13. The method of claim 8 further comprising dispensing a fluid onto a sheet that is disposed on at least one member of the set of sides while vibrating at least one member of the set of sides.

14. The method of claim 8 further comprising dispensing a fluid through a sheet that is disposed on at least one member of the set of sides while vibrating at least one member of the set of sides.

15. A cushion comprising:
a mesh member comprising a set of filaments of thermoplastic material, wherein each member of the set of filaments is looped and bonded to at least one other member of the set of filaments, the mesh member defining a first side that comprises a repeating non-planar profile.

16. The cushion of claim 15 wherein the mesh member further comprises a second side and comprises a second repeating non-planar profile.

17. The cushion of claim 15 wherein the mesh member further comprises a second side that is disposed opposite the first side and the second side does not comprise the repeating non-planar profile.

18. The cushion of claim 15 wherein the repeating non-planar profile is a waveform.

19. The cushion of claim 15 wherein the repeating non-planar profile is a periodic waveform.

20. The cushion of claim 19 wherein the repeating non-planar profile is a sinusoidal waveform.
